(19) United States
(12) Patent Application Publication
(10) Pub. No.: US 2011/0115824 A1
(43) Pub. Date: May 19, 2011

(54) Multimedia Codec System and Method Providing Bink Support

(75) Inventors: James Lawrence, Henderson, NV (US); Frederick L. Longacre, Henderson, NV (US); Ravi Dharmashetty Patlegar, Bangalore (IN)

(73) Assignee: BALLY GAMING, INC., Las Vegas, NV (US)

(21) Appl. No.: 12/618,679

(22) Filed: Nov. 13, 2009

(51) Int. Cl. H04N 7/26; G09G 5/00

(52) U.S. Cl. 345/672; 386/E05.003

(57) ABSTRACT

Various embodiments disclosed herein are directed to an audio/video codec engine system and method for a gaming machine. The method displays content using a multimedia codec engine system with BINK support. The method includes: loading a multimedia file into memory from a disk; decoding a frame from memory to the off-screen buffer when requested by the video engine, wherein decoding a frame from the off-screen buffer requires a seek operation to a proper position in the multimedia file; and performing a draw operation on decoded data from the off-screen buffer that was requested by the video engine, wherein the draw operation may request only a target region of the source resolution to be updated by specifying an update region that is smaller than the source resolution.

### COPYRIGHT NOTICE

A portion of the disclosure of this patent document contains material that is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### FIELD

This disclosure relates generally to a gaming system and, more particularly, to a system and methodology for providing enhanced audio/video codec engine.

### BACKGROUND

BINK is a “better-than-DVD” class codec and highly-compressed format that is widely used in the gaming industry. BINK was developed by RAD Game Tools and has gained widespread use on a variety of game console platforms such as PlayStation and X-Box. BINK is an effective codec that achieves industry-level compression, places an emphasis on lower decoding CPU requirements, supports Alpha (blending) channel, and is optimized specifically for computer games. To encode and view the content, the codec libraries are required. BINK provides a tool to encode content from popular formats such as QuickTime, AVI, and a series of PNG images on the Window Platform. The encoding tools may be run from the command-line. Additionally, the encoding tools may be used to conveniently play back the BINK content.

BINK supports both movies and still frame encodings. However, BINK targets movies more than stills. The BINK codec utilizes lossy block-compression technology similar to MPEG and RealVideo. A lossy compression method is one where data is compressed and then decompressed, which may well retrieve data that is different from the original, but is close enough to be very useful, with significant memory savings being realized in the process. The encoding scheme enables a user to set the output bitrate, which controls the quality of the content. It is important to note that quality, like compression ratios, varies over the complexity of content. Furthermore, the speed of the encoder is not real-time which aids the compression technology to output the best quality content for the bitrate chosen. In this regard, real-time encoding is not a requirement for most gaming applications.

BINK has a powerful, optimized decoding SDK (software developer kit) available for Linux. The content may be programmatically loaded from a file or memory. Continuing, individual frames may then be decoded to a variety of raw formats appropriate for display. Detailed API (application program interface) documentation and sample code accompanies the SDK.

Currently, most applications that require graphics go through a video server application. The video server is a user space process that manages video display. Clients talk to the video server via a game API video library that sends inter-process communication (IPC) messages. The video server supports the following formats from disk for still images: (1) TIFF (Tagged Image File Format), which is currently only uncompressed format supported; and (2) PNG (Portable Network Graphics) format, which employs lossless data compression. The video server supports the following formats from disk for moving picture content: (1) MNG (Multiple-image Network Graphics) format; and (2) FLC, which is a proprietary FLIC format.

These file formats support lossless compression on the disk for modest compression ratios. The video server currently only accesses the disk files during boot. The flash disk access time is too slow for streaming playback. Thus, all multimedia files are loaded from disk into memory before the boot completes. The multimedia files are loaded into memory in an internal format or left as raw, neither of which is the same format as that which is used on the disk. The internal format for video is a lossless run length scheme. The internal decompression scheme runs reasonably quick for typical animations and has been optimized to integrate with alpha-blending requirements. However, internal compression is time-consuming during the boot, compression ratios are modest, and it requires too much CPU utilization for complex content.

Video can use a large amount of memory in gaming applications. In this regard, newer and more advanced video technologies can require even larger amounts of memory. Such large memory requirements can dramatically increase overall costs and efficiency. For example, one particular type of video, OpenGL, uses about five-to-ten times more memory than older video formats. OpenGL (Open Graphics Library) is a standard specification defining a cross-language, cross-platform API for writing applications that produce computer graphics. These levels of memory requirement are not practical for mainstream use.

Currently, video engines in use by Alpha products support MNG (Multiple-image Network Graphics), FLC, and BINK formats for files on disk. After the gaming machine boots, the disk file is ignored and only in-memory RAM is used. In other words, only in-memory formats are used to control the content that a player sees. Realistically, the only in-memory formats currently supported are BINK, FLC, and an untitled in-house format, called Alpha RLE. Still the MNG format is too slow for practical use, and hence, is never supported. FLC has proven unpopular with game development.

The Alpha RLE format is a run-length codec. Generally, Alpha RLE does about half as well as PNG (Portable Network Graphics), which is a bitmap (raster) graphic file format. Alpha RLE cannot support 24-bit effectively. Furthermore, Alpha RLE is not lossless, and it adds considerably to boot time of a gaming machine since no file support exists for the format. Nevertheless, Alpha RLE is fast with respect to playback during game play.

Another alternative solution that exists is MPEG. MPEG-4 minimally is required, as MPEG-2 does not support the Alpha channel. However, MPEG-4 requires considerably higher CPU usage than BINK. NVIDIA cards partially support MPEG-4 in decoding in hardware. However, decoding as a part-software/part-hardware solution in the board only supports doing the algorithm's basic building blocks in hardware. The texture download to the device and associated software component complexity would roughly equal BINK in speed. Importantly though, the manufacturer has not yet provided Linux drivers for MPEG-4 decoding by NVIDIA hardware, leaving it moot for now.

Accordingly, it would be desirable to use more advanced audio and video technologies with the same or lower memory and CPU requirements as legacy servers.

### SUMMARY

Briefly, and in general terms, various embodiments are directed to an audio/video codec engine system and method for a gaming machine. The method displays content using a multimedia codec engine system with BINK support. The method includes: loading a multimedia file into memory from a disk; decoding a frame from memory to the off-screen buffer when requested by the video engine, wherein decoding a frame from the off-screen buffer requires a seek operation to a proper position in the multimedia file; and performing a draw operation on decoded data from the off-screen buffer that was requested by the video engine, wherein the draw operation may request only a target region of the source resolution to be updated by specifying an update region that is smaller than the source resolution.

Other features and advantages will become apparent from the following detailed description, taken in conjunction with the accompanying drawings, which illustrate by way of example, the features of the various embodiments.

### BRIEF DESCRIPTION OF THE DRAWING

FIG. 1 illustrates a block diagram of the components of a gaming device.

FIG. 2 illustrates an interaction diagram is shown that illustrates the collaborations of these components.

FIG. 3 illustrates a class diagram is shown that illustrates some of interfaces between these modules.

FIG. 4 illustrates software architecture for BINK (video) support without compression.

FIG. 5 illustrates software architecture for BINK (video) support with a compressed flag set.

FIG. 6 illustrates a path of execution on an OpenGL video server when an advance frame is performed in a BINK movie

FIG. 7 illustrates a first image that is all key frame blocks and must be decoded and rendered.

FIG. 8 illustrates the image of FIG. 7 with the door opening, and in which the next image must be completely re-rendered since all of the blocks are dirty.

FIG. 9 illustrates the image of FIG. 7 with the door opening, and in which the background region behind door has not changed, hence this region need not be re-rendered or have a re-blit operation performed.

FIG. 10 illustrates the image of FIG. 7 with the completely open, and in which most regions do not need to be re-rendered or have a re-blit operation performed.

FIGS. 11 and 12 illustrate the implementation of render avoidance for static regions of foreground in which a stick figure moves across the screen and only movie areas with the figure's movement changed.

FIG. 13 illustrates a relationship in the block diagram between the Wavemixer, Intermediate mixer, Buffer manager, Audio Buffers, and File Handler components.

FIG. 14 illustrates an audio functionality performed by creating a mapping between a File Handle ID's (FHID) and an internal object which represents a current frame of BINK data, which has already been decoded.

FIG. 15 illustrates one embodiment of a gaming device including the secured module for validating the BIOS.

FIG. 16 illustrates one embodiment of a gaming system network including the gaming devices of FIG. 15.

### DETAILED DESCRIPTION

Various embodiments disclosed herein are directed to gaming devices having a system and method for implementing a BINK supporting audio/video codec engine system that provides a fast, high-quality, low-bit-rate codec optimized for gaming machine level requirements. The multimedia codec engine system supports both audio and video formats of BINK through legacy video and OpenGL video servers. Specifically, the multimedia codec engine system preferably provides: (1) reduced memory usage (since currently many games struggle to stay within a 512 MB limit); (2) improved boot up times; (3) reduced disk usage; and (4) improved CPU usage for alpha blending.

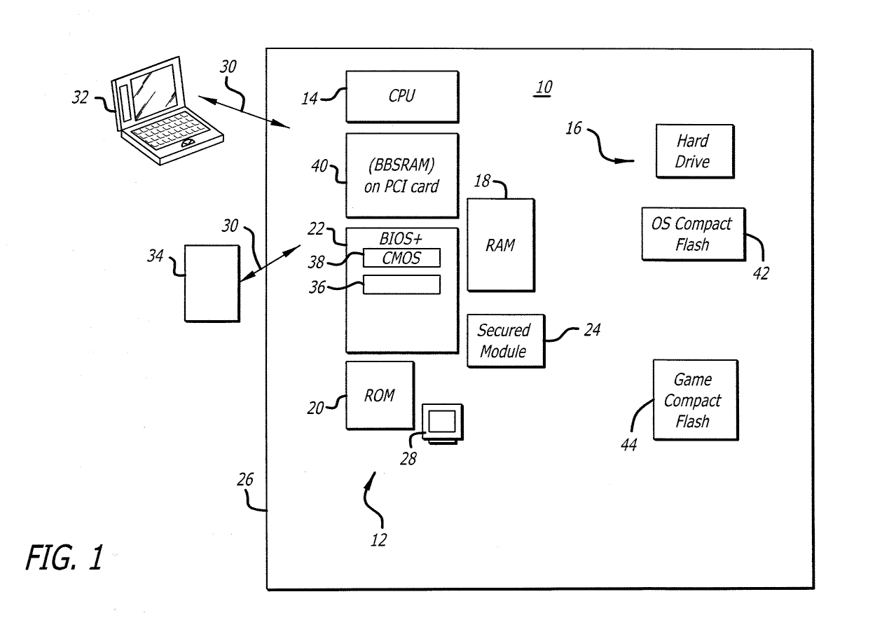

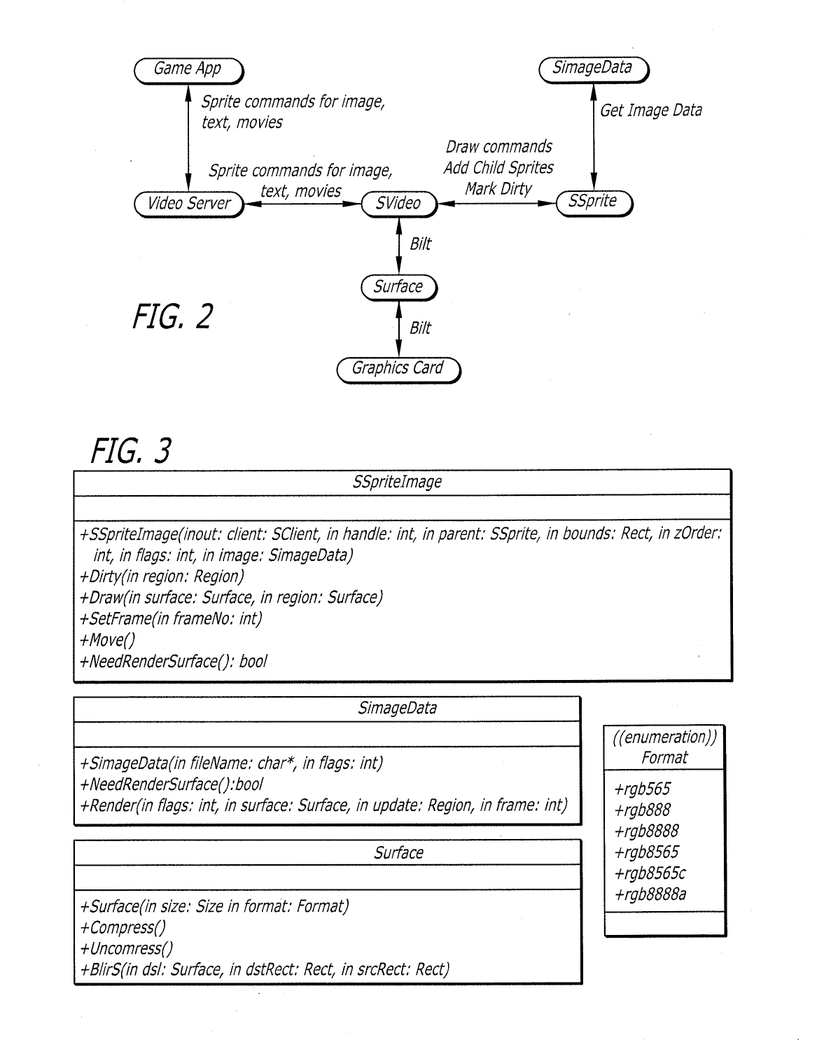

As described herein for consistent terminology, a “draw” operation is the rendering of a source image to the off-screen surface, and a “blit” operation is the rendering of the off-screen surface to the device. Referring now to the drawings, wherein like reference numerals denote like or corresponding parts throughout the drawings and, more particularly to FIGS. 1-2, there are shown various embodiments of a gaming system employing a video codec engine system.

The multimedia codec engine system performs the following tasks to render updates. This is performed independently of format. The tasks include: (1) Handle any move, show, play, or other commands from its clients; (2) Compute which regions need to be updated from the list of dirty sprites and the sprites position in front of other sprites; (3) Update the off-screen surface call by iterating the dirty rectangles to draw to it; and (4) Perform a “blit” operation to the device from updated areas of the off-screen surface.

In one embodiment of the multimedia codec engine system, BINK support minimally requires: (1) Loading the file into memory from disk. (2) Decoding a frame from memory when requested by the video update engine to the off-screen buffer. This may involve a “seek” to the proper position in the multimedia file. (3) Performing a “draw” of decoded data to the off-screen buffer provided video update engine. The draw operation can request only part of the target region of the source be updated by specifying an update region smaller than the source resolution. Hence, the draw operation of the rendering requires proper clipping operations.

Additionally, in one embodiment of the multimedia codec engine system, BINK optimizations include: (1) Rendering from the decoding buffer to an off-screen buffer in performed one-pass. Preferably, only a single decoding buffer is required. (2) Image drawing to the off-screen buffer is integrated with alpha blending. For example, a render request should be in the output format of RGB565 not RGB8565. (3) Opaque pixels are not blended. (4) Regions of image that are fully opaque do not require a re-drawing of images that are behind them, regardless of whether or not the sprite flags are transparent. (5) Regions of an image that are fully-transparent do not require a draw operation. (6) A blit operation is not required if a fully transparent region of an image has no image behind it that has changed. (7) Regions of an image that have not changed from the previous frame should not require a draw operation or a blit operation unless the engine indicates the surface needs to be refreshed. (8) Clipping should only be run with the associated “ifs” when it is known that the entire image is not needed. For example, a surface-to-surface blit routine that loops over sub-regions needs two versions, one that performs clipping, and one that safely assumes that clipping not needed. (9) A facility is provided to unload memory that is known not to be in use. In this regard, a worst-case memory usage is reduced by providing an API (application program interface) to programmatically release unused files. The file image in memory cannot be released but memory associated with handles and buffers can be released, when indicated by the client application (e.g., the gameapp).

Referring now to the audio components of the multimedia codec engine system, a sound server for a gaming machine contains a component that enables playback of BINK files to reduce storage and memory requirements for audio files. Using BINK compression achieves approximately a 10 to 1 compression ratio over the WAV audio format currently used. The audio component may be integrated into the current sound server. The BINK supported, audio components of the multimedia codec engine system is configured to (1) reduce memory/disk storage requirements of the sound server, and (2) support currently-acceptable, audio industry standards for sound in a gaming environment.

The incorporating of BINK audio into the multimedia codec engine system enables loading of a compressed file into memory and decoding the audio on the fly as it is needed by the client. In this manner, the memory and storage space requirements to store a whole uncompressed file are eliminated. When decoding BINK audio, a library is utilized that performs low-level, decode functions use in BINK audio. In one embodiment of the multimedia codec engine system, the audio code integrates into an existing sound server as a “buffer object” that has the responsibility to provide samples to the core of the sound server when a method is called.

FIG. 1 illustrates a block diagram of the components 12 of a gaming device 10. The components 12 comprise, for example, and not by way of limitation, software or data file components, firmware components, hardware components, or structural components of the gaming machine 10. These components include, without limitation, one or more processors 14, a hard disk device 16, volatile storage media such as random access memories (RAMs) 18, read-only memories (ROMs) 20 or electrically-erasable programmable ROMs (EEPROMS) such as basic input/output systems (BIOS) 22. Additionally, the gaming device 10 includes a secured module 24. The secured module is a hardware component that is one-time programmable. One or more security algorithms may be provided on the secured module. The security algorithm generates a challenge (e.g., generates a random number), calculates an expected response to the challenge, and determines the validity of the BIOS based on the response to the challenge provided by the BIOS. In one embodiment, the secured module is a field-programmable gate array (FPGA). In another embodiment, the secured module is a trusted platform module (TPM).

In one embodiment, components 12 also include data files (which are any collections of data, including executable programs in binary or script form, and the information those programs operate upon), gaming machine cabinets (housings) 26, displays 28, or compact disk read-only memory (CDROM) or CD read-write (CR-RW) storage. In one embodiment, the data files may include data storage files, software program files, operating system files, and file allocation tables or structures. Ports 30 are be included with the gaming machine 10 for connection to diagnostic systems 32 and other input/output devices 34. In one embodiment, the ports 30 each comprise a serial port, universal serial bus (USB) port, parallel port or any other type of known port, including a wireless port. Preferably, each of the components 12 have embedded or loaded in them identification numbers or strings that can be accessed by the processor 14, including the processor 14 itself, which are utilized for authentication as explained below. In one embodiment, the components that are data files, each use their file path and name as their identification number or string.

Either within the gaming machine 10, or in the diagnostic system 32 attachable to the gaming machine 10, are executable instructions or a software program 36 for authentication of the components (authentication software 36), which itself may be one of the components 12 to authenticate if it is internal to the gaming machine 10. In one embodiment, authentication software 36 is stored on a persistent storage media such as the hard disk device 16, ROM 20, EEPROM, in a complementary metal oxide semiconductor memory (CMOS) 38, in safe RAM comprising a battery-backed static random access memory (BBSRAM) 40, in flash memory components 42, 44, or other type of persistent memory. In one embodiment, the authentication software 36 is stored in a basic input/output system (BIOS) 22 device or chip. BIOS chips 22 have been used for storing prior authentication software, such as previous versions of the BIOS+chip used by Bally Gaming Systems, Inc. of Las Vegas, Nev. in their EVO gaming system. Placing the authentication software 36 in the BIOS 22 is advantageous, because the code in the BIOS 22 is usually the first code executed upon boot or start-up of the gaming machine 10, making it hard to bypass the authentication process. Alternatively, in one embodiment, the authentication software 36 is stored in a firmware hub (FWH), such as Intel's 82802 FWH.

As alternative, instead of, or in conjunction with, the hard disk device, another mass storage device is used, such as a CD-ROM, CD-RW device, a WORM device, a floppy disk device, a removable type of hard disk device, a ZIP disk device, a JAZZ disk device, a DVD device, a removable flash memory device, or a hard card type of hard disk device.

It should be noted that the term, gaming device, is intended to encompass any type of gaming machine, including hand-held devices used as gaming machines such as cellular-based devices (e.g., phones), PDAs, or the like. The gaming device can be represented by any network node that can implement a game and is not limited to cabinet-based machines. The system has equal applicability to gaming machines implemented as part of video gaming consoles, handheld, or other portable devices. In one embodiment, a geo-location device in the handheld or portable gaming device may be used to locate a specific player for regulatory and other purposes. Geo-location techniques that can be used include by way of example, and not by way of limitation, an IP address lookup, a GPS, a cell phone tower location, a cell ID, a known Wireless Access Point location, a Wi-Fi connection used, a phone number, a physical wire or port on a client device, or by a middle tier or backend server accessed. In one embodiment, GPS and biometric devices are built within a player's client device, which in one embodiment, comprises a player's own personal computing device, or provided by the casino as an add-on device using USB, Bluetooth, IRDA, serial or other interfaces to the hardware to enable jurisdictionally-compliant gaming, ensuring the location of play and the identity of the player. In another embodiment, the casino provides an entire personal computing device with these devices built in, such as a tablet-type computing device, a PDA, a cell phone or another type of computing device capable of playing system games.

Referring now to FIGS. 2-14, in one implementation of a multimedia codec engine system with BINK support, a legacy video server is employed. In this regard, a brief overview of a legacy video server is presented below. The major components of the video server are as follows: SVideo, Server, Server, SSprite, SImageData, and Gameapp. The SVideo manages video rendering and updates. The Server handles incoming requests to be processed and delegates the requests to an appropriate module. The Server renders from buffer to buffer converting from one format type to another, if needed. The SSprite provides a general image reference for movies, labels, and images. Its also includes a list of child sprites. The SImageData provides a sub-container for image data associated with a sprite. Lastly, the Gameapp is a game application that is client of video services.

FIG. 2 illustrates an interaction diagram which shows the collaborations of these above-listed components. Referring now to FIG. 3, a class diagram is shown that illustrates some of interfaces between these modules. In one embodiment of the multimedia codec engine system, the BINK support implements the SImageData interface as a SImageDataBINK implementation class. Preferably, the SImageData class is responsible for managing the BINK-supported, multimedia codec engine system. Further, it provides image data, as requested, to the video engine. Modifications may be made to optimize performance outside the BINK class, if those modifications apply to other file formats as well. The SImageData interface is very simple. First, the constructor loads the file. Next, the flags are passed from the SSprite owner. The flags originate from the game application.

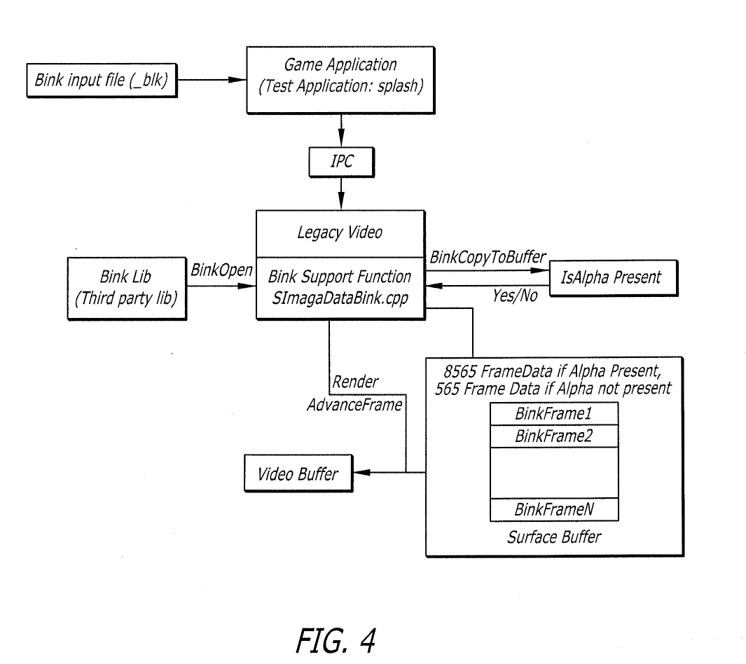

Referring now to FIG. 4, BINK support from legacy video with software architecture is shown. Specifically, FIG. 4 shows software architecture for BINK (video) support without compression. In one embodiment, a library libbinklnx.a provides a BINK library API. The BINK file received from video client is passed to a BINKOpen( ) API function. This function returns a structure for the BINK file which contains a number of frames, current frame, width, height, and the like. In one embodiment, legacy video uses the BINKCopytoBuffer function to copy the BINK frame data to the local buffer, which is called screen buffer. This buffer data is decoded into the 565 format for 16-bit format support or 8656 format for 32-bit alpha transparency support. After decoding the data into the legacy video format, the buffer data is kept in a surface buffer.

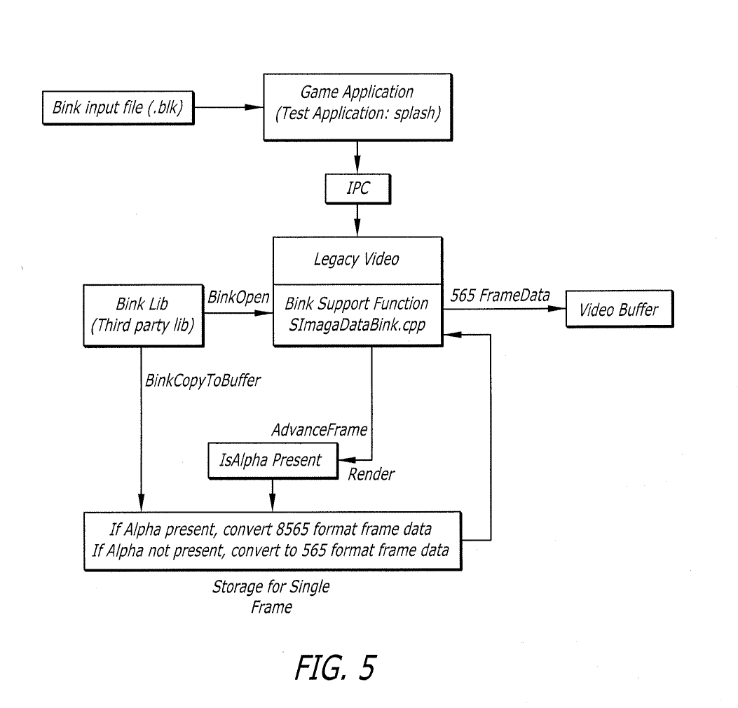

Referring now to FIG. 5, a logical flow diagram is shown of BINK processing with a compressed flag set by an application client. Otherwise stated, FIG. 5 illustrates software architecture for BINK (video) support with a compressed flag set. When a compressed flag is set by application for input.bik file, the BINK file is read and the frame is copied to a single buffer during a Render ( ) function call. After copying data to the buffer, the buffer data is converted to 8565 format in case a transparency flag is set, otherwise it is kept in 565 format. To make the compression default processing, a rawformat flag is introduced in the game application APIs. When the rawformat flag is not set, the video server (by default) does the processing using the compression mode. During run time, the video server uses only one frame of buffer data. All buffers in both cases are finally transferred to SurfaceToSurfaceBlit ( ) function for further conversion of data into final pixel format conversion (565 format with alpha into consideration).

Construct and Load the Image Object.

@param filename The filename to be processed.

@param flags flags indicate options for rendering behaviour.
compressed=indicates in memory compressed.
transparent=file has transparency information.
   does NOT indicate if fully transparent or opaque.

SImageData(const char*fileName, int flags=0).

In one embodiment, the following NeedRenderSurface function is returned as false. No additional copying is required by the render engine to process BINK content.

Tells the Render Engine to Render to an Offscreen Surface Before Rendering to the Canvas.

@Return returns true if the image requires an additional surface besides the offscreen surface canvas virtual bool NeedRenderSurface ( ).

The bulk of the work is done by the Render call to update the surface from image data.

Renders the Image to the Given Surface, Updating the Indicated Regions Only.

@param flags rending options

@param surface offscreen buffer

@param update areas to update

@param frame frame number

@param dirty current unused
virtual void Render (int flags,
Surface & surface,
const Region & update,
short frame=0,
Region*dirty=NULL).

Each of these interface prototypes remains unchanged. Additionally, each interface's implementation details require special consideration. A discussion of each function's implementation details is described below for clarification. With respect to an OpenGL video server, a review is performed by replacing a surface object with the OpenGL engine and the SImageData object with the Image object in the interaction diagram of the legacy video server overview.

By plugging into the OpenGL video server, the BINK support implements the Image interface as a BINKImage implementation class. The BINKImage class is responsible for managing the BINK codec and providing image data as requested to the video engine. BINK support in the OpenGL server is unaffected by the optimizing of the Alpha blending externally from the BINKImage. The BINKImage does not copy data from fully-transparent regions. Furthermore, the BINKImage also does not copy data from regions that did not change from a previous frame using the BINK API. With respect to the Image interface, the flags originating from the game application are forwarded to the BINKImage from the constructor.

Load the Image Object.

@param filename The filename to be processed.

Image::Open(const char*fileName).

Construct Image Object.

@param format compressed or raw format.

BINKImage(BINKFormat format).

The bulk of the work is done by the PrepareFrame call to update the Texture from image data.

Renders the Image to the Texture.

@param frameNo rending options.

virtual void PrepareFrame (int frameNo):

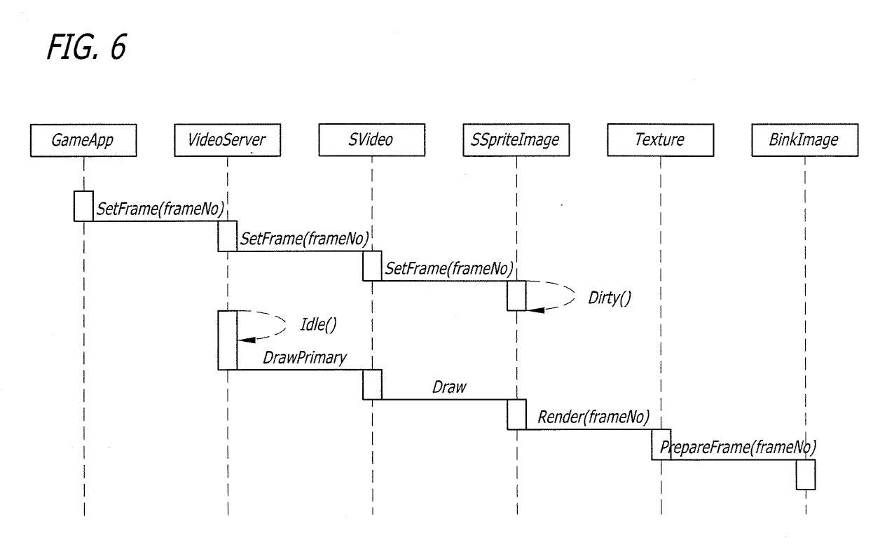

The following sequence diagram, shown in FIG. 6, illustrates the path of execution on an OpenGL video server when an advance frame is performed in a BINK movie. In one embodiment of the multimedia codec engine system, the decoding process is begun by loading the data of the entire file into memory. Preferably, the file may not be reloaded from the disk. This is due to the fact that the access time of the flash media is too slow for practical purposes. When loading a file into memory for playback, the options are to keep the file format: (1) the same as on disk; (2) recompress to another format; or (3) keep the format the same expected by the video hardware. Currently, the MNG (Multiple-image Network Graphics file format) is loaded and recompressed into the internal format.

BINK support includes support for option (1), which is specified by the sprite flag of “compressed.” The content is read from a disk as is, with no need to re-encode. Support for option (2) is supported but is of limited usefulness. Option (3) is supported by specifying a new flag of rawformat. The rawformat uses a great amount of memory since no compression is used, but it can yield speed improvements.

The loading of a file into memory is performed by creating a memory buffer and reading from the file into the buffer. To access the BINK data the BINK API is used. The BINK API requires a handle, called a HBINK, for most of the function calls. The BINK handle is obtained by using the BINKOpen API.

BINK API: Opens the Specified Bink File for Decompression.

@param filename The name of the file to open.

@param openflags The flags to use when opening the file.
BINKFILEHANDLE indicates pointer parameter points to the file data, not a filename.
BINKNOFRAMEBUFFERS indicates not to allocate frame buffers, are allocated manually.
BINKALPHA indicates to decode Alpha channel if it is present in the file.

@return Handle to the opened BINK file or zero on error.

HBINK BINKOpen(CHAR_PTR file_name, BINK_OPEN_FLAGS open_flags).

So, the first step to access the data is to call the BINK API call. The BINKOpen passes into a memory buffer of the read file. The handle contains useful basic information about the multimedia such as resolution, duration, and the like, for various computations.

In one embodiment of the multimedia codec engine system, the next step is for the images to be preprocessed upon loading in order to properly optimize the fully-transparent and fully-opaque regions of the images. The information is being stored in RAM as a list of tile's structures. The tiles provide critical information that is required to optimize the drawing operations and blitting operations in later stages. In other embodiments, the tile information may be stored on the disk to save pre-processing time.

In another aspect of the multimedia codec engine system, only the alpha channel is required for preprocessing in the compressed mode. Hence, decoding the image data for preprocessing is not done when a compressed flag is set. The BINK API is modified by RAD Game Tools to return the Alpha channel only, and not to require a BINKDoFrame, which decodes the image data.

Alpha-channel preprocessing involves identification of which regions are translucent, opaque and blended. The image is broken into tiles of size (TILE_SIZE×TILE_SIZE). Each block is processed to determine if it is all opaque, translucent, or blended.

IdentifyAlphaCategory(in uint8 * data):
pixel = data[0]
for x from 1 to data.size
begin
if pixel != data[x]
break;
end
if (x==data.size and pixel==OPAQUE)
opaqueRegions |= currentRegion
else if (x==data.size && pixel==TRANSPARENT)
no operation
else
blendRegions |= currentRegion.

After all blocks are processed, there are two lists of regions: one for opaque and one for blended. Translucent regions do not require processing, so they are deliberately omitted. Adjacent tiles in the lists are then merged into a single tile if the shape can still be described by a rectangle. In one embodiment of the multimedia codec engine system, the video server code already supports this optimization via the Region::Optimize call. The lists may be used by the render or blit operations to optimize properly.

In another embodiment, the smaller the TILE_SIZE, the more processing loop time and memory is required for the tile structures, but the greater number of regions that can be optimized. A suitable TILE_SIZE of 16 is initially determined based upon experience and moderate experimentation, but eight may be used when higher processor platforms are available. The preprocessing for rawformat requires the image data be stored. The data is stored in tiles. Typically, the data compresses slightly using this method since fully-transparent regions are not stored.

Referring now to the decoding process using the multimedia codec engine system, the SImageData::Render/BINKImage::PrepareImage call is made when the render engine needs the image data to update its offscreen surface. The render call indicates the frame number in the sequence it is targeting. Additionally, to update the offscreen surface, the source image data must first be decoded. An important step in the decoding process is establishing the position on the proper frame number in the sequence. The BINK API supports a “seek” function via the BINKNextFrame/BINKGoto calls. BINKNextFrame takes no parameters and proceeds to the next frame using what was decoded last as a guide. The BINKGoto function is an arbitrary seek.

BINK API: Moves to the Next Video Frame in the Bink File.

@param BINK Specifies the BINK handle.

void BINKNextFrame(HBINK BINK).

BINK API: BinkGoto Jumps to a New Frame Inside the Bink File.

@param BINK Specifies the BINK handle.

@param frameNum Specifies the frame number to jump to.

@param gotoFlags Specifies the type of jump to perform.

0 Jump by seeking to the nearest key frame and then decompressing up to your specified frame.

QUICK Jump directly to the frame, and not bother with the key frame seek first

(frames after jump to may be displayed incorrectly).

void BINKGoto(HBINK BINK,U32 frameNum,BINK_GOTO_FLAGS gotoFlags).

From the API, it may be determined that the BINKGoto is much more expensive than BINKNextFrame, since previous dependencies must be satisfied with BINKGoto, whereas BINKNextFrame may safely assume that they are met. The GOTOQUICK parameter should not be used since it results in blocks having no data provided for them if they were differentially encoded. Positioning in BINK is performed by BINKGoto only when the target frame does not equal the next frame in the sequence. Once positioned properly, the target frame in the sequence may be decoded.

The BINK API BINKDoFrame is then called. The BINKDoFrame requires no input parameters. The result in stored in the handle's structures for extraction to the render surface.

BINK API: Decompresses the Next Frame of Video.

@param BINK Specifies the BINK handle.

void BINKDoFrame(HBINK BINK).

In another aspect of the multimedia codec engine system, after decoding the source image, the render call's second step is to update its off-screen surface. The render call indicates the surface to which to copy the frame number in the sequence that it is targeting, and the dirty region (which is possibly smaller than the image's resolution) that must be updated.

The BINK BINKDoFrame API outputs the decoded image data to the handle's image buffers in YUV color-space. To extract the image in RGB format, the BINK API BINKCopyToBuffer functions are provided. The BINKCopyToBuffer functions enable the caller to specify the output format. The SImageDataBINK object requests the format RGB 565 and obtains the alpha buffer in a separate array since this format most closely matches the offscreen surface's format to which the SImageData::Render function is trying to output. The OpenGL BINKImage requests the 8888 format.

BINK API: Copies a Piece of the Video Frame to a Specified Memory Address.

@param BINK Specifies the BINK handle.

@param dst_addr Address of the destination memory buffer.

@param dst_pitch Pitch of the destination buffer in bytes.

@param dst_height Height of the destination buffer in pixels.

@param dst_x X (left) pixel offset into the destination buffer.

@param dst_y Y (top) pixel offset into the destination buffer.

@param src_x The X pixel offset in the internal BINK buffer.

This must be divisible by 16 unless you use the BINKCOPYALL flag.

@param src_y The Y pixel offset in the internal BINK buffer.

@param src_w The width in pixels to copy.

@param src_h The height in pixels to copy.

@param flags Indicates destination buffer format and other special copy options.
SURFACE24 24-bit RGB data (BGRBGR, etc).
SURFACE32A 32-bit native RGB data with alpha (On Win32: BGRABGRA, etc).
SURFACE24R 24-bit reversed RGB data (RGBRGB, etc).
SURFACE32RA 32-bit reversed RGB data with alpha (RGBARGBA, etc).
SURFACE565 16-bit 565 RGB high-color surface.
COPYALL Copy all of the pixels to the destination buffer, not just the pixels that changed.
Normally, BINK tries to copy just the pixels that changed to destination buffer.
This flag causes BINK to re-copy every pixel over to the destination buffer.
S32 BINKCopyToBufferRect(HBINK BINK, VOID_PTR dst_addr, S32 dst_pitch, U32 dst_height, U32 dst_x, U32 dest_y, U32 src_x, U32 src_y, U32 src_w, U32 src_h, BINK_COPY_FLAGS flags).

The BINKCopyToBuffer functions copy only the pixels that have changed from the previous frame into the destination buffer. For example, single-frame images always have all pixels changed. However, multi-frame sequences are differentially encoded. Blocks that have not changed from the previous frame are detected by the decoder and not copied.

For an OpenGL server, the BINKCopyToBuffer function is used to copy a sub-rectangle of the BINK's internal YUV buffers to the output RGB surface buffer, which is the output of the render function.

For a legacy video server, BINKCopyToBufferRect is called for each rectangle in the input parameter update region list. BINKCopyToBufferRect function is an extension to the BINKCopyToBuffer function that can copy a sub-rectangle of BINK's internal buffers instead of the whole resolution. The BINKCopyToBufferRect is used instead of the BINKCopyToBuffer, since usually only part of the entire video frame is requested by the SImageData::Render callee. The BINKCOPYALL flag is passed since the BINKCopyToBufferRect function otherwise skips blocks that have not changed since the previous frame was decoded. The sub-rectangle passed by the SImageData::Render callee is updated unconditionally since the offscreen surface may be modified. The callee is held accountable to not pass in regions that may be known ahead of time to have not changed.

In one embodiment, the image decoded is clipped to the output update region list specified by the Render callee. Typically, the clipping involves a series of “if” statements that control the render bounds before any copying loop occurs. The bounds set the number of rows, columns, and starting points of the pixels.

The psuedocode for SImageData::Render looks like the following:

SImageData::Render(Surface offScreenBuffer, RegionList updateRegions, short

frameNo)

{
if (frameNo==0 ∥ lastframeNo+1=frameNo)

BINKNextFrame(handle)

else

BINKNextFrame(handle)

lastframeNo=frameNo
BINKDoFrame(handle)
for rgn each updateRegionList
foreach otile in opaqueList
{

GetClippedRegion (updateRegionList.next, clipdRgn);
BINKCopyToBufferRect (handle, buffer, scanlineSize, imageHeight,
clipdRgn.xPos, clipdRgn.y,
clipdRgn.xPos, clipdRgn.yPos, clipdRgn.width, clipdRgn.height,
COPYALL);
Draw (staticBuffer, offScreenBuffer, scanlineSize, imageHeight,
clipdRgn);

}
For each btile in blendList
{

GetClippedRegion (updateRegionList.next, clipdRgn);
BINKCopyToBufferRect (handle, buffer, scanlineSize, imageHeight,
clipdRgn.xPos, clipdRgn.y,
clipdRgn.xPos, clipdRgn.yPos, clipdRgn.width, clipdRgn.height,
COPYALL);
AlphaBlendDraw (staticBuffer, offScreenBuffer, scanlineSize,
imageHeight, clipdRgn);

}
}

In still another aspect of the multimedia codec engine system, efficient alpha blending is important to performance since it may be very expensive. An OpenGL server handles alpha blending using an OpenGL API. Legacy video implements alpha blending itself. Alpha blending is defined for each red, green and blue component as:

result=ALPHA*srcPixel+(1−ALPHA)*destPixel

The equation may be optimized to the algebraically equivalent operations of:

result=ALPHA*srcPixel+destPixel−ALPHA*destPixel

result=ALPHA*(srcPixel−destPixel)+destPixel

Since values are in 565 format, a single multiply of a long in following RGB format may work without destructive overflow ramifications of unrelated components.

00000ggg gg00000 rrrrr000 000bbbbb

The source and destination pixel are converted by a simple shift and mask, the subtract/multiply/add for blend performed, and then the 565 format is restored. Translucent regions are skipped, with no processing done at all. Opaque regions are rendered with a different routine from blending regions. Opaque regions are rendered with a simple memory copy.

In one embodiment of the multimedia codec engine system, a buffer containing the entire file is allocated permanently for each file. During playback, a BINK Handle is required. The BINK handle uses roughly (width*height)/2 bytes for the YUV image and associated structures. If the file is a single image, the YUV image buffer does not need to be allocated. The YUV buffer may be shared from a statically-allocated structure used for all single frame images. The SImageDataBINK object may set the handle's memory for statically-allocated buffers by calling BINKOpen with a BINKNOFRAMEBUFFERS flag set and passing the static pointers to a BINK API call to the BINKRegisterFrameBuffers API.

The only other memory required besides the file buffer and the handle is negligible. An off-screen buffer is not required to store the results from BINKCopyToBuffer. In some embodiments, the tile structures of number order (width/TILE_WIDTH)*(height*/TILE_WIDTH) are required. The tile structures may use shorts instead of ints to save memory.

Referring now to alpha blending optimization and background render avoidance for translucent foregrounds, these aspects are described by the following example. In one such non-limiting scenario, a clip of a set of doors opening is shown in a scene. The scene behind the doors is a static image that does not change. The doors are initially closed. As the door opens, the door opening between the doors, as they open, is fully transparent. The door is closed.

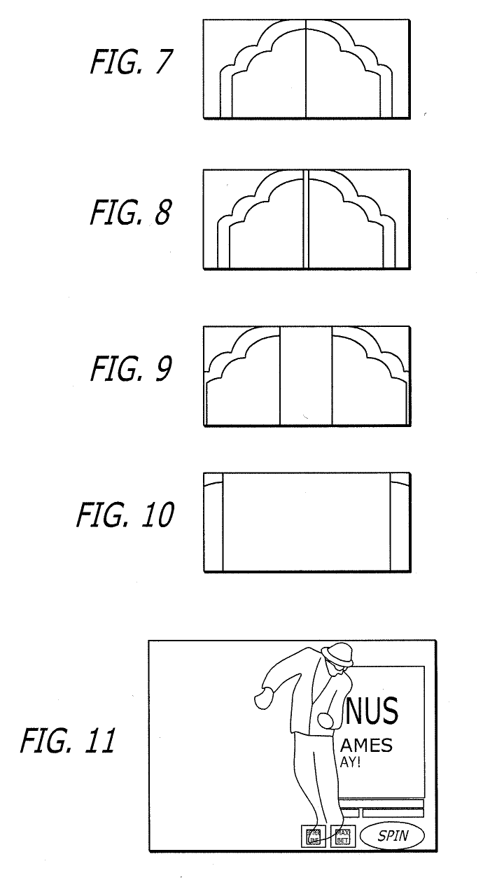

The first image, shown in FIG. 7, is all key frame blocks and must be decoded and rendered. As shown in FIG. 8, the door is opening. Since all blocks are dirty, the next image must be completely re-rendered. As shown in FIG. 9, the door is opening, and the background region behind the door has not changed, hence this region need not be re-rendered or have a re-blit operation performed. As shown in FIG. 10, with the door completely open, most regions do not need to be re-rendered or have a re-blit operation performed.

Currently, in one embodiment of the multimedia codec engine system, the video engine redraws the background image. The engine looks at the sprite flags as transparent and assumes that the redraw must be performed. The MNG format does not yet support this function, since the format does not pre-process the data for tile information. The SImageDataBINK returns the regions that are fully opaque. Furthermore, the video engine excludes from its dirty region, the sprite regions behind these opaque regions from requiring draw operations.

In addition, currently the video engine performs a re-blit operation on the surface in the opening even though it is fully transparent, and the region behind it has not changed. The SImageDataBINK returns regions that are too opaque, as well as blending regions as required. The video engine may then build its blit region based upon these regions. Simply using a sprite to move across the screen may solve both of these instances. In this regard, each “Play Next Frame” command may be followed by a “Move” command. However, the coding time that is required to construct a program that properly animates is a valued parameter. In addition, a sprite may not accurately describe the moving object is target content-capable of background render avoidance. Furthermore, games have already been released and cannot be recoded.

In another aspect of the multimedia codec engine system, usage of the OpenGL (Open Graphics Library) API provides a viable solution since OpenGL implements transparency extremely efficiently and utilizes the hardware to do alpha blending when possible. However, the OpenGL support currently requires more memory for MNG type content than is currently feasible, without requiring hardware updates.

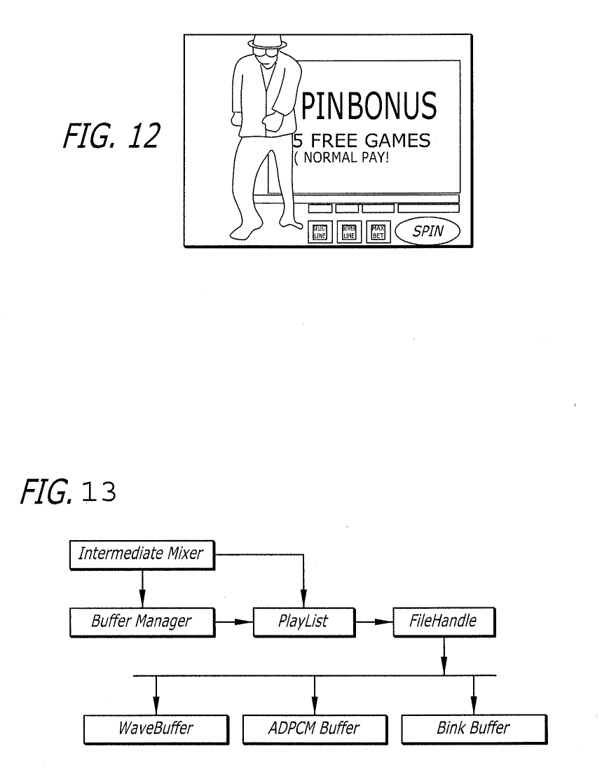

In yet another aspect of the multimedia codec engine system shown in FIGS. 11 and 12, render avoidance is implemented for static regions of foreground. In one such embodiment, a stick figure moves across the screen. Only movie areas with the figure's movement changed. Preferably, the other areas are not dirty, therefore, the areas do not need to be re-drawn or re-blit. Importantly for this example, the blocks have not changed.

In one embodiment, the render engine does not “know” whether the blocks have changed or not, the render engine only knows about transparency levels. However, the codec is inherently aware of what blocks have changed and what has not. This configuration returns a region list of blocks that have changed so that the render engine may skip those blocks that have not changed. The BINK API supports this feature using the BINKGetRects call, which returns a list of dirty rectangles from one frame to the next. OpenGL implementation in BINKImage utilizes BINKGetRects call to only draw to sub-image regions that have changed. Since rendering is done in hardware, this is likely that any speed improvements are negligible.

In a preferred embodiment of the multimedia codec engine system, BINK video provides an attractive addition to current technology. Memory usage is dramatically improved. The CPU cost for most clips is tolerable. The format which is utilized is optional, and thus, situations that do not perforin well may be replaced with alternative technology. MPEG4, JPEG, a simple compression in-house technology for buttons are some examples of the alternative technology.

The multimedia codec engine system is configured to reduce memory usage by utilizing BINK compression. The memory savings may be used to encode more content or possibly utilize other techniques with the memory, which would in turn reduce CPU usage. Typically though, it is anticipated CPU utilization may be slightly higher for BINK-encoded content since decoding that content takes CPU power. However, it is possible that CPU utilization may be decreased for certain multimedia encoded with BINK. Additionally, boot time of games may be decreased through the implementation of a multimedia codec engine system that supports BINK, since file sizes of multimedia and associated pre-processing are greatly reduced.

In an embodiment of the multimedia codec engine system that supports BINK, performance is significantly enhanced. The following numbers forecast average expected results based on experimentation and analysis.

| | Ratio | Explanation |
|---|---|---|
| Disk Usage for Movies: | | |
| Content | | |
| MNG/FLC | 8:1 | Uses Differential encoding |
| | | and ZIP. |
| BINK | 40:1 | DCT/wavelet transform, |
| | | motion compensation |
| | | and differential encoding. |
| Disk Usage for Stills: | | |
| Content | | |
| PNG | 3:1 | Uses ZIP. |
| TIF | None | No compression supported |
| BINK | 15:1 | DCT/wavelet transform, |
| | | motion compensation |
| | | and differential encoding. |
| Memory Usage for Movies: | | |
| Content | | |
| Internal | 3:1 | Uses run-length encoding, |
| | | works better on highly |
| | | redundant content |
| BINK | 30:1 | Some memory is required |
| | | for programmatic control |
| | | (API handle) |
| CPU Usage for Movies: | | |
| Content | | |
| RAW | baseline | Huge memory requirements. |
| Internal | 5% | Run length decoding |
| BINK | 25% | Should run about half-speed |
| | | of a memcpy of equivalent |
| | | resolution. |

| Quality: Content | Explanation |
|---|---|
| Internal | Lossless |
| BINK | Imperceptible at 16:1 for most content. |
| | Not noticeable at 30:1. |

| Boot Time: Content | Ratio | Explanation |
|---|---|---|
| Internal | baseline | Requires decoding MNG content |
| | | and re-encoding to internal format. |
| BINK | 2x less | No decoded or re-encoding required. |
| | in video | Limited pre-processing. |

Referring now to audio aspects of the BINK-supported, multimedia codec engine system, the incorporation of BINK audio into the existing sound server loads a compressed file into memory and decodes the audio on the fly as it is needed by the client, thus eliminating the memory and storage space required to store the whole uncompressed file. When decoding the BINK audio, a library is employed which performs low-level decode functions required for BINK audio. The code integrates into the existing sound server as a “buffer object” whose responsibility is to provide samples to the core of the sound server when a method is called.

The existing sound server consists of the following components: Wavemixer, Intermediate mixer, Buffer manager, Audio Buffers, and File Handler. The Wavemixer handles hardware-level communications to the sound card. The Intermediate Mixer manages play lists and executes commands from the client. The Buffer Manager manages allocation and reference counting of the audio buffers. The Audio Buffer retrieves and decodes audio data for each playing file handle. The File Handler represents an instance of playing file, and reads data on a sample basis from audio buffers.

Referring now to FIG. 13, the relationship is shown in the block diagram between the above listed components. To facilitate this architecture, the multimedia codec engine system implements: (1) Creation of a BINKBuffer object (similar to existing WaveBuffer and ADPCMBuffer objects which decode their respective formats); and (2) Modification of the File Parser to recognize that a BINK File is being played.

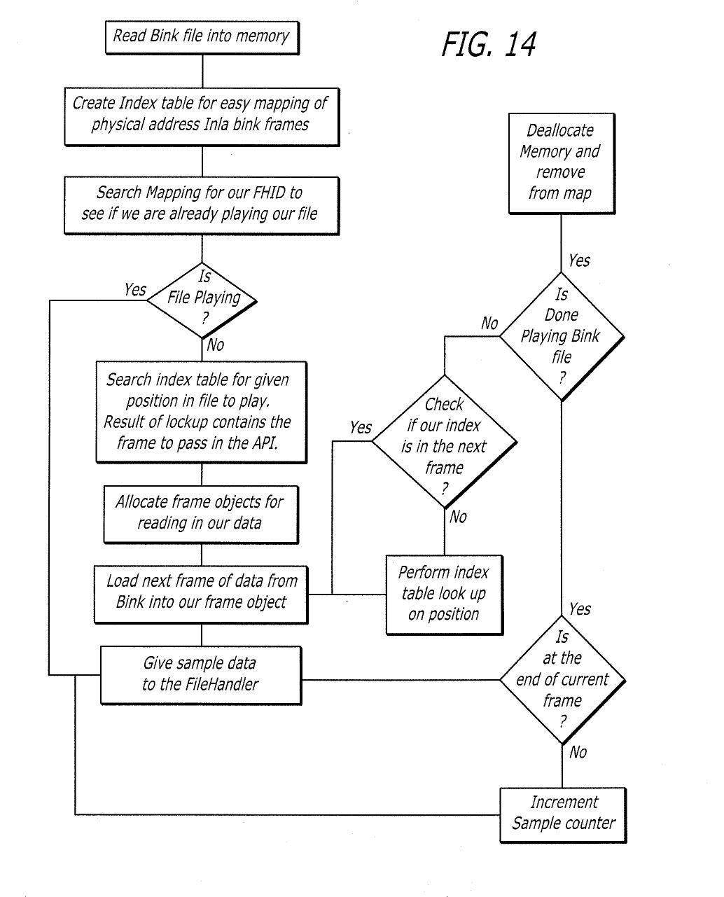

Referring now to FIG. 14, the audio functionality of the multimedia codec engine system performs by creating a mapping between a File Handle ID's (FHID) and an internal object which represents the current frame of BINK Data, which has already been decoded. When the GetSegment ( )method is called by the sound server, the FHID searches the map for current objects. If the object is found, then the file is played. If the object is not found in the map, then a new object must be created that represents the FHID, and memory must be allocated for it. Upon initialization, the BINK class builds an index table for each BINK file, which resides in memory until the object is destroyed.

In one embodiment, the BINK audio buffer integrates into the existing sound server architecture. When a client requests the server to play a sound file, a File Handle ID (FHID) is created in the sound server. An instance of the class File Handle is created for each FHID open on the server. Each instance of this FHID has associated with it a reference counted version of the proper buffer object for a specific sound file format. Thus, each sound file is associated with a Buffer. However, each sound buffer may have multiple FHID's accessing it at any point in time. Since the legacy WAV and ADPCM files are loaded into memory in their entirety, each instance of the File Handle class has an index which marks that particular file handle playback point in the file. Notably, when decoding BINK, only one frame at time is decoded, and thus, the file by frames may only be randomly accessed.

In one embodiment of the multimedia codec engine system, a mapping between FHID's and buffer objects is created that contains information about the particular frame which is being decoded. Additionally, memory is allocated for each FHID playing on a frame-by-frame basis. Accordingly, memory for each buffer object is deallocated when a particular BINK file is decoded to completion.

In another aspect of the multimedia codec engine system, BINK audio is decoded in variable length frames which are decoded as needed. To efficiently achieve this process, an index table is created on initialization which contains frame information so that a prompt lookup is ensured when audio data is requested. While playing a sound, this index table is used to translate the byte counter in the FileHandle.cpp class into a frame number to be sent to the BINK API if it is determined to be in the next frame, or to generate an offset in the current frame. Each index in this table contains the size of the frame as well as a starting offset in bytes. In this manner, when an arbitrary index is passed in bytes from the sound server, the system goes through the index table and compares this number to the starting address of each entry. By using this method, the multimedia codec engine system provides the ability to jump to any point in the BINK clip.

Referring now to the legacy sound interface, BINK support uses the IBuffer interface for the CBINKBuffer class to plug to the legacy audio server. The IBuffer class is responsible for managing the BINK codec, providing audio data as requested to the audio server. In one embodiment, due to the audio server design, changes are made to other areas of the audio server.

class IBuffer
{
public:
IBuffer(void) { }
virtual ~IBuffer(void) { }
// Get a segment of audio data from the buffer
virtual void GetSegment(class IFileHandle*) = 0;
// Return the sample rate of this buffer
virtual unsigned short GetRate(void) const = 0;
// FLL Called when FH is destructed to make sure that our BINK

buffer object mapped to this fhid is destructed

virtual void Release(unsigned int fhid) {
}
};

In one embodiment of the multimedia codec engine system, the interface class is quite straightforward. In this regard, a release method is added to the interface which supports the decoding algorithm, since this calls an overridden function in the CBINKBuffer. This ensures that when a FileHandle is destructed, its associated index and memory are removed from the CBINKBuffer class.

Referring now to the loading of content, an entire file's data must be loaded down into memory. This is accomplished by using the MMAP system call with results in the file being mapped to shared memory. In this manner, the audio and video may then be played from the same file and the same space in memory simultaneously, even though audio and video run in two completely separate processes.

With respect to preprocessing, the compressed audio is preprocessed to create an index table, so that arbitrary lookups may be performed on an arbitrary position in the file. In the existing sound server architecture, sounds are played from start to end without jumping to arbitrary positions in a given file, so one can argue about the point of an index table. However, since the WAV and ADPCM implementation support this function, BINK supports this function as well. The format of the index table is as follows:

typedef struct IndexObject_ {
int FrameNum;
unsigned int FrameSize;
unsigned long FrameOffset;
unsigned int vectorindex;
} IndexObject;
FrameNum - Frame of audio in BINK file.
FrameSize - Size of frame in bytes.
FrameOffset - Offset of frame in bytes.
Vectorindex - Index in array where this structure instance lives.

Using this table, given an arbitrary byte index, it may be determined which frame and to which offset in the frame a sample belongs.

In another aspect of the multimedia codec engine system, the CBINKBuffer::GetSegment call is made when the sound server needs a sample of data from the buffer. In this situation, an object is passed as a parameter which contains the byte offset, and an instance variable. The system looks up the instance value in a map which contains a mapping between the instance and an object which tracks its state. If the instance is located in the map, the next sample of available data is returned. Otherwise, something new is played. In this case, a new object is created, the byte offset in the index table is looked up, the frame that was looked up is decoded, and the object is stored. Each time GetSegment is called, a single sample is returned from this object until the end of the frame is reached. Continuing, the next offset in our index table in looked up, with this process being repeated until the playing is completed.

Extensive tests have been performed with the BINK supported, multimedia codec engine system decoding on several different games. The profiling results depend heavily on the quality of the encoding of the BINK file. When playing at maximum quality (minimum compression) sample WAV files were compressed from around 3:1 to 5:1. If the “lossiness” is increased (and in turn, quality decreased), the compression may exceed 15:1. As a relative comparison, on the Lucky Luigi's Pizzeria game, the memory profiling tests show the following:

Compression set to 4/99 (0 is lossless, 99 is most loss).

| With BINK | |
|---|---|
| (Compression factor 4/99) | Without BINK (wav files) |
| 12.6mb | 36mb |

As mentioned above, this is with minimum compression and is about 3:1 which is consistent with the relative sizes of the files. If maximum compression is used, this ratio could get higher than 12:1. BINK Audio performs extremely well, and seems to be very efficient, both on the CPU as well as the memory usage. Using a BINK audio supported, multimedia codec engine system enables activities that were not previously possible, such as simultaneous playback of video and audio in the same file, and encoding multiple audio streams in a single file.

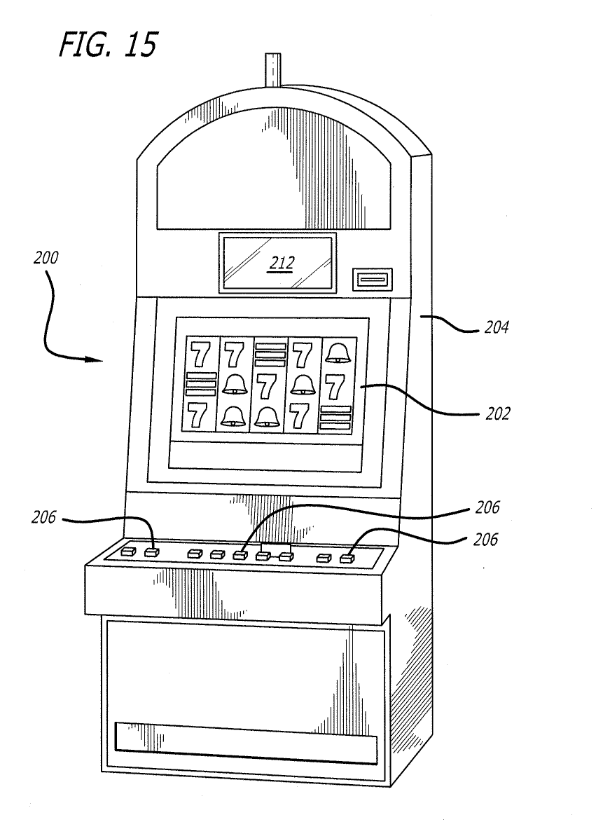

FIG. 15 illustrates one embodiment of a gaming device including the secured module for validating the BIOS. Turning to FIG. 15, the main cabinet 204 of the gaming machine 200 is a self-standing unit that is generally rectangular in shape. In another embodiment, the main cabinet 204 may be a slant-top gaming cabinet. Alternatively, in other embodiments, the gaming cabinet may be any shaped cabinet known or developed in the art that may include a top box. Additionally, the cabinet may be manufactured with reinforced steel or other rigid materials that are resistant to tampering and vandalism. Optionally, in an alternate embodiment, the gaming machine 200 may instead be a cinema-style gaming machine (not shown) having a widescreen display, as disclosed in U.S. application Ser. No. 11/225,827, entitled “Ergonomic Gaming Cabinet,” filed on Sep. 12, 2005, which is hereby incorporated by reference.

As shown in FIG. 15, the gaming machine 200 includes a main display 202. According to one embodiment, the main display 202 is a plurality of mechanical reels for presenting a slot-style game. Alternatively, the main display 202 is a video display for presenting one or more games such as, but not limited to, mechanical slots, video slots, video keno, video poker, video blackjack, video roulette, Class II bingo, games of skill, games of chance involving some player skill, or any combination thereof.

According to one embodiment, the main display 202 is a widescreen display (e.g., 16:9 or 16:10 aspect ratio display). In one embodiment, the display 202 is a flat panel display including by way of example only, and not by way of limitation, liquid crystal, plasma, electroluminescent, vacuum fluorescent, field emission, LCOS (liquid crystal on silicon), and SXRD (Silicon Xtal Reflective display), or any other type of panel display known or developed in the art. These flat panel displays may use panel technologies to provide digital quality images including by way of example only, and not by way of limitation, EDTV, HDTV, or DLP (Digital Light Processing).

According to one embodiment, the widescreen display 202 may be mounted in the gaming cabinet 204 in a portrait or landscape orientation. In another embodiment, the game display 202 may also include a touch screen or touch glass system (not shown). The touch screen system allows a player to input choices without using any electromechanical buttons 206. Alternatively, the touch screen system may be a supplement to the electromechanical buttons 206.

The main cabinet 204 of the gaming machine also houses a game management unit (not shown) that includes a CPU, circuitry, and software for receiving signals from the player-activated buttons 206 and a handle (not shown), operating the games, and transmitting signals to the respective game display 206 and speakers (not shown). Additionally, the gaming machine includes an operating system such as Bally Gaming's Alpha 05, as disclosed in U.S. Pat. No. 7,278,068, which is hereby incorporated by reference.

In various embodiments, game programs may be stored in a memory (not shown) comprising a read-only memory (ROM), volatile or non-volatile random access memory (RAM), a hard drive or flash memory device or any of several alternative types of single or multiple memory devices or structures.

As shown in FIG. 15, the gaming machine 200 includes a plurality of player-activated buttons 206. These buttons 206 may be used for various functions such as, but not limited to, selecting a wager denomination, selecting a number of games to be played, selecting the wager amount per game, initiating a game, or cashing out money from the gaming machine 200. The buttons 206 function are input mechanisms and may include mechanical buttons, electromechanical buttons or touch-screen buttons. In another embodiment, one input mechanism is a universal button module that provides a dynamic button system adaptable for use with various games, as disclosed in U.S. application Ser. No. 11/106,212, entitled “Universal Button Module”, filed Apr. 14, 2005 and U.S. application Ser. No. 11/223,364, entitled “Universal Button Module”, filed Sep. 9, 2005, which are both hereby incorporated by reference. Additionally, other input devices, such as but not limited to, a touch pad, a track ball, a mouse, switches, and toggle switches, are included with the gaming machine to also accept player input. Optionally, a handle (not shown) may be “pulled” by a player to initiate a slots-based game.

One of ordinary skill in the art will appreciate that not all gaming devices will have all these components or may have other components in addition to, or in lieu of, those components mentioned here. Furthermore, while these components are viewed and described separately, various components may be integrated into a single unit in some embodiments.

In some embodiments, the gaming machine 200 is part of a gaming system connected to or with other gaming machines as well as other components such as, but not limited to, a Systems Management Server (SMS) and a loyalty club system (e.g., casino management personnel/system (CMP/CMS)). Typically, the CMS/CMP system performs casino player tracking and collects regular casino floor and player activity data. The gaming system may communicate and/or transfer data between or from the gaming machines 200 and other components (e.g., servers, databases, verification/authentication systems, and/or third party systems).

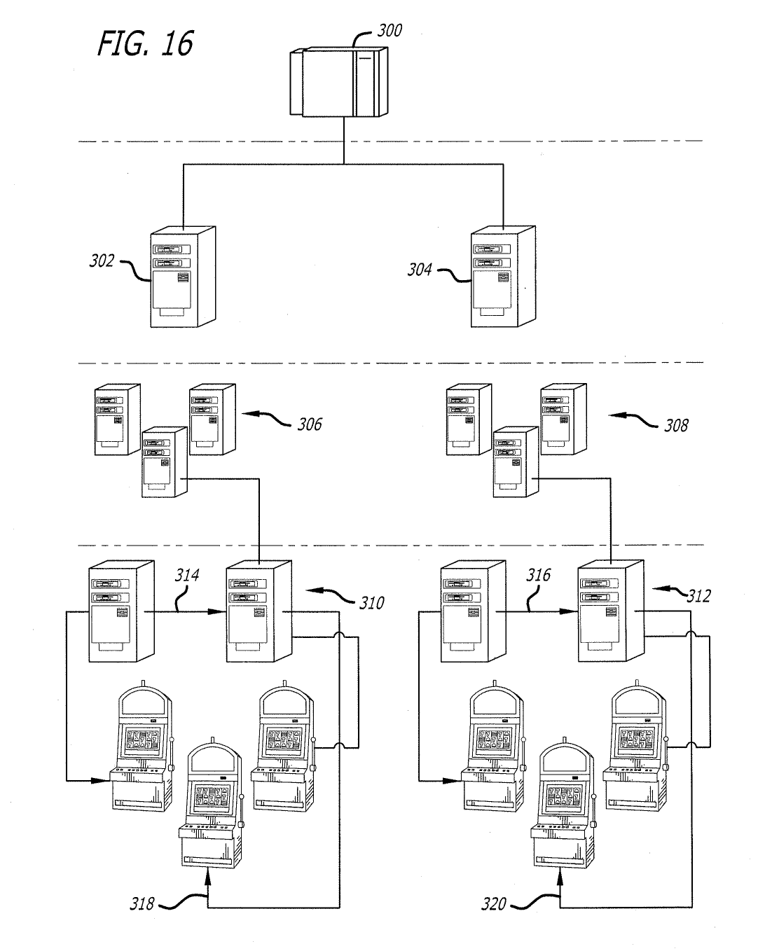

An embodiment of a network that may be used with the system is illustrated in FIG. 16. The example network consists of a top-level vender distribution point 300 that contains all packages for all jurisdictions; one or more Jurisdiction distribution points 302 and 304 that contain regulator-approved, production signed packages used within that jurisdiction or sub-jurisdiction; one or more Software Management Points 306 and 308 to schedule and control the downloading of packages to the gaming machine; and one or more Software Distribution Points 310 and 312 that contain regulator approved production signed packages only used in the gaming establishment that it supports. The Software Distribution Points (SDPs) 310 and 312 can communicate with Systems Management Points (SMPs) 314 and 316, respectively as well as directly to one or more gaming machines 318 and 320. The system allows for rapid and secure distribution of new games, configurations, and OS's from a centralized point. It makes it possible to update and modify existing gaming machines with fixes and updates to programs as well as providing modifications to such files as screen images, video, sound, pay tables and other gaming machine control and support files. It provides complete control of gaming machines from a centralized control and distribution point and can minimize the need and delay of human intervention at the gaming machine. In one embodiment, the configuration control may be from the SDPs 101 or 104 or from the gaming servers 103.

The various embodiments described above are provided by way of illustration only and should not be construed to limit the claimed invention. Those skilled in the art will readily recognize various modifications and changes that may be made to the claimed invention without following the example embodiments and applications illustrated and described herein, and without departing from the true spirit and scope of the claimed invention, which is set forth in the following claims.

What is claimed:

1. The method for displaying content using a multimedia codec engine system with BINK support, the method comprising:
loading a multimedia file into memory from a disk;
decoding a frame from memory to the off-screen buffer when requested by the video engine, wherein decoding a frame from the off-screen buffer require a seek operation to a proper position in the multimedia file; and
performing a draw operation on decoded data from the off-screen buffer that was requested by the video engine, wherein the draw operation may request only a target region of the source resolution to be updated by specifying an update region that is smaller than the source resolution.

2. The method of claim 1, further comprising rendering from a decoding buffer to an off-screen buffer in a single one-pass.

3. The method of claim 1, further comprising integrating an image drawing to the off-screen buffer with alpha blending, wherein opaque pixels are not blended.

4. The method of claim 1, wherein regions of an image that are fully opaque do not require re-drawing of images that are behind them, regardless of whether or not sprite flags are transparent.

5. The method of claim 1, wherein regions of an image that are fully transparent do not require a draw operation, wherein a draw operation is a rendering of a source image to an off-screen surface.

6. The method of claim 1, wherein a blit operation is not required if a fully transparent region of a front image does not have a rear image behind the front image that has changed, wherein a blit operation is a rendering of an off-screen surface to a display device.

7. The method of claim 1, wherein regions of an image that have not changed from a previous frame do not require a draw operation or a blit operation unless the system indicates that a surface needs to be refreshed, wherein a blit operation is a rendering of an off-screen surface to a display device, and wherein a draw operation is the rendering of a source image to an off-screen surface.

8. The method of claim 1, wherein the draw operation of the rendering requires clipping operations.

9. The method of claim 1, wherein only a single decoding buffer is required.

10. The method for rendering updates using a multimedia codec engine system with BINK support, the method comprising:
initiating a command from a client, wherein commands include move, show, play, or combinations thereof;
computing which regions are to be updated from a list of dirty sprites and sprites positioned in front of other sprites, wherein a sprite is a graphic image that can move within a larger graphic image;
updating an off-screen surface call by iterating dirty rectangles to draw to it; and
performing a blit operation to the device from updated areas of the off-screen surface, wherein a blit operation is the rendering of an off-screen surface to display device.

11. The method of claim 11, wherein the multimedia codec engine system enables reduced memory usage.

12. The method of claim 11, wherein the multimedia codec engine system enables improved boot up times.

13. The method of claim 11, wherein the multimedia codec engine system enables reduced disk usage.

14. The method of claim 11, wherein the multimedia codec engine system enables improved CPU usage for alpha blending.

15. The method of claim 11, further comprising eliminating the memory and storage space requirements to store a whole uncompressed file.

16. The method of claim 11, further comprising utilizing a library to perform low level decoding functions.

17. The method of claim 11, further comprising integrating code into an existing server as a buffer object that has the responsibility to provide samples to a core of the server when a method is called.
